(19) United States
(12) Patent Application Publication
(10) Pub. No.: US 2005/0247817 A1
(43) Pub. Date: Nov. 10, 2005

(54) Paper towel dispenser with fixed frictional gripping bar

(76) Inventor: William Holden, Durango, CO (US)

Correspondence Address: KILE GOEKJIAN REED & MCMANUS, 1200 NEW HAMPSHIRE AVE, NW, SUITE 570, WASHINGTON, DC, 20036, US

(21) Appl. No.: 11/124,237

(22) Filed: May 9, 2005

Related U.S. Application Data
(60) Provisional application No. 60/568,702, filed on May 7, 2004.

(51) Int. Cl. B65H 16/04; B26F 3/02

(52) U.S. Cl. 242/597.5; 225/106

(57) ABSTRACT

An apparatus for one handed dispensing paper sheet segments from a roll of paper sheet segments connected end-to-end along transverse serration lines including a base member, a support connected to a base for holding a roll of paper sheet segments and a frictional gripping element connected to the base that has a high friction segment. The frictional gripping element may also contain an arcuate inner surface for pivotal movement and contact with respect to a roll of paper sheet segments.

### CROSS-REFERENCE TO RELATED APPLICATION

This application relates to and claims full priority to Provisional Application Ser. No. 60/568,702 filed on May 7, 2004. The disclosures of this earlier filed application are incorporated herein by reference as though set forth at length.

### BACKGROUND OF THE INVENTION

This invention relates to a novel paper sheet dispenser. More specifically, the present invention is directed to a single hand, paper towel or tissue sheet dispenser that does not require a user to hold a roll of segmented, paper sheets with one hand in order to facilely tear off a desired number of the paper sheet segments.

Paper towels are routinely used in kitchens, restaurants and other settings where food is prepared and served. No matter where food is served, paper towel dispensers are often used to dispense paper towel sheets to clean up spills or to clean tables, floors and kitchen appliances. In addition, paper towel dispensers are often used in recreational settings, in addition to garages, auto or wood working shops and in other work or recreational areas where people need to absorb or wipe-up a spill, dry a surface or simply clean and/or dry their hands. Paper towels are usually sold in a roll having a width of approximately eleven inches or so and sheets of approximately six to fifteen inches in length connected end-to-end along serrated tear lines. The paper towel and bath tissue sheets are wound upon a paper core of approximately an inch and a half in diameter and sell with a retail diameter of the roll of about four to five inches in diameter.

Paper towels are often formed from one or two ply sheets of absorbent paper material. One brand of such paper towel product is known as BOUNTY, which is a registered trademark of the Proctor & Gamble Company. This brand comes in sheet lengths of a few inches or so to approximately eleven-by-eleven inches square. Another brand is referred to as BRAWNY which is a registered trademark of the Fort James Corporation and is conventionally sold in a roll of sheets eleven inches wide by thirteen point eight inches in length joined end-to-end along serration tear lines. In certain instances, sheets of paper towels may have other length and width dimensions. However, most disposable paper towel rolls have periodic transverse serrations to facilitate separation of discrete lengths or sheets.

In addition to paper towels, bathroom tissues are dispensed in segmented rolls which are unreeled and torn-off in desired numbers for use.

The above paper sheet products are often dispensed by using a simple U-shaped bracket holder. These holders are usually designed to be mounted upon a vertical wall surface or beneath a horizontal wood cabinet by wood screws. Each end of the U-shaped bracket is designed to hold one end of the paper sheet core or alternatively a rod can be axially extended through the center of the paper core and mounted at its ends between the U-shaped bracket or frame. At least one disadvantage of traditional paper sheet dispensers, including a simple U-shaped bracket holder, is that a person usually needs to use both hands to dispense the paper sheets. This disadvantage represents an inconvenience and difficulty for some people, when one hand is holding a container, object of use, or is otherwise soiled or occupied. In such moments, the only option, in most instances, is for a person to find a place to set the container or other object of use so that both hands are free to tear off one or more sheets of paper product. If a user attempts to use inertia and jerk a few sheets from a roll, the roll often unreels. The user is then left with the task of rewinding unused numbers of paper product segments. In other instances, if a user attempts to use inertia to tear sheets from a roll, the entire roll may be pulled off the holder. The user must then pick up the roll rewind any useful portion and reposition the roll on the holder. Still further, if a roll of paper sheet segments is held with one hand, and a desired number ripped off with the other, the sheets of paper product may not tear at the serrated edges between individual sheets. This leaves uneven or jagged edges or strips of paper sheets hanging from the roll.

It would therefore be highly desirable to provide a means for dispensing different types of segmented paper, sheets that only requires a user to use a single hand to facilely tear off any number of paper sheets desired in a reliable and convenient manner. In addition, it would be desirable to provide a means for dispensing segmented paper sheets wherein a user can use a single hand to tear off segmented, paper sheets without touching or soiling other sheets of the roll of paper product with a user's hand.

Traditional paper sheet dispensers, including dispensers for paper towels, are often poorly designed or cheaply produced which means that a roll of paper sheets often falls off the dispenser when a person attempts to tear off a segment. Therefore, it would be desirable to provide a paper sheet dispenser that is rugged and reliable in design and function and will securely retain a roll of paper sheets during a dispensing procedure.

At least one paper sheet dispenser, known in the past, that is designed to operate with one hand, includes a pair of nesting plastic yokes that are pivotally connected to a base plate. In this design, a paper sheet roll is mounted on one of the yokes and trained over a top edge of the other yoke for tearing by a downward movement. In one embodiment this tearing operation is enhanced by use of tooth-shaped projections or a sharp blade fitted at an edge of the second yoke to assist in separating a desired number of sheets from a roll This design, although more convenient than most traditional roll dispensers, is composed of relatively light-weight plastic and a multipart mounting mechanism for the yokes. Accordingly, this design lacks ruggedness and does not take advantage of gravity to assist in a dispensing process. Moreover, the tear mechanism is simply an over a yoke bar design that is lacking user friendliness for a one handed operation.

In at least one further prior design, a roll of paper sheets was operably received within a trough with a slit along one edge of the bottom of the trough. A free end of the roll was trained through the slit and therefore operated as a dispensing unit. In this device there is nothing to brake rotation of the roll, except a user's second hand and therefore while this design will dispense paper sheet segments it exhibits many of the limitations of prior designs.

Traditional paper sheet dispensers do not provide an effective mechanism for limiting the unreeling of a roll of paper sheets except with the use of two hands. It would be desirable to enable a user to dispense one or more paper sheets using a single hand. Moreover, it would be useful to enable a user, relying on just one hand, to be able to reliably and conveniently dispense paper sheets from a dispenser mounted either against a wall or under a cabinet.

In the past paper sheet dispensers also did not have means for mounting the dispenser in different positions in a manner that provides for alternative left or right side loading of a roll of segmented, paper sheets on the dispenser and reliable single hand operation of the dispenser. Loading and operation of a paper sheet dispenser enables a user to use a single hand to tear off a desired number of sheets of paper product from either the left side or right side of the dispenser in a reliable and convenient manner. Therefore, it would be desirable to provide a means for dispensing segmented, paper sheets such that the dispensing unit can be mounted in different positions, such as against a generally vertical surface or in a generally horizontal mounting position such as under a cabinet, either in a kitchen or other work or recreational area, wherein the dispensing means is designed for reversible loading and operation. Such dispensing means would enable a user to reliably and conveniently mount a segmented, paper sheet, dispenser on either the right side or left side of a generally planar surface, for convenient dispensing of segmented, paper sheets. It would also be desirable to provide a means for dispensing segmented, paper sheets that can be mounted on a wood or plastic surface with screws or on a metallic surface by utilizing a permanent magnet and optionally wherein a base may be utilize to display personal or decorative pictures or designs or information for ready reference. A table top version is also desirable. The dispensing means would be mounted on a table top stand. The dispenser can be optionally oriented vertically.

Another single hand, paper sheet dispenser in the prior art allows for bi-directional operation and is adaptively mountable as is the present invention. The main difference between this prior art and the subject invention is in the construction and components comprising the dispensing member. In the prior art, the dispensing bale was comprised of an inner brake bar and a outer tear bar such that a roll of paper sheets positioned on the core holder were generally trained in an under/over path for braking rotation of the roll during a one handed dispensing operation. The subject invention does not require the use of an inner brake bar and an outer tear bar for one handed dispensing operation. To facilitate one handed dispensing the subject invention requires only a frictional gripping element having at least one frictional element. Additionally, the frictional gripping element utilizes frictional force between a frictional segment of the element and the free end of a roll of paper sheets to prevent further unreeling of the roll of paper sheets when conducting a one handed dispensing operation.

It would further be desirable, in at least one embodiment of the invention, to provide a means for dispensing segmented paper sheets, including paper towels, wherein the dispensing means is composed of metal components or other construction which provides strength to the structure. Another embodiment employs a non-metallic frictional material. Still another embodiment uses a polymer frictional material. Yet another embodiment uses a rubber material.

In view of the limitations of traditional paper sheet dispensers, it would be therefore be desirable to provide a means for dispensing segmented paper sheets that enables a user to dispense segmented paper sheets with a single hand in a reliable and convenient manner, and which incorporated novel, desirable elements referred to above.

The difficulties and limitations suggested in the preceding are not intended to be exhaustive, but rather are among many which demonstrate that paper sheet dispensers appearing in the past will admit to worthwhile improvement.

### OBJECTS OF THE INVENTION

It is a general object of the invention to provide a single hand dispenser of segmented paper sheets that will obviate or minimize problems and achieve desired advantages of the type previously described.

It is a general object of the invention to provide a single hand dispenser of segmented paper sheets wherein a desired number of one or more segmented paper sheets, may be facilely removed by one free hand without using a second hand that may be in use, soiled or otherwise occupied.

It is a specific object of the invention to provide a single hand dispenser of segmented paper sheets which utilizes a single frictional gripping element limiting a tendency of the roll of paper sheets to unreel during one handed dispensing operation.

It is another specific object of the invention to provide a frictional surface, single hand dispenser of segmented paper sheets for facilitating tearing of a desired amount of paper segments from a roll.

It is a general object of the invention to provide a single hand dispenser of segmented paper sheets wherein the dispenser may be mounted in a position for loading and dispensing paper sheets on either the right side or left side of a base plate, such that a user may use a single hand to operably dispense a desired number of sheet segments and is mounted on either the right side or the left side of a base plate.

It is another object of the invention to provide a “table top” device that is not secured in any way; but rather, comprises a base that rests on a horizontal surface.

It is another object of the invention to provide a single hand dispenser of segmented paper sheets wherein the dispenser may be operably mounted on vertical wood, plastic or metal surfaces or beneath horizontal surfaces such as cabinets.

It is another object of the invention to provide a single hand dispenser of segmented paper sheets wherein the dispenser continues to be highly effective in use, with only one hand, even as the size of the roll of segmented paper sheets decreases.

It is still another object of the invention to provide a single hand dispenser of segmented paper sheets wherein a roll of segmented paper sheets is automatically retained to prevent rotation as a sheet of paper is torn from the roll.

It is yet a further object of the invention to provide a single hand dispenser of segmented paper sheets wherein undesired unreeling of too many segmented paper sheets is avoided even though a selective number of a sheet segment is torn off with a single, one handed, stroke.

Still further, it is an object of the invention to provide a single hand, segmented, paper sheet dispensing system that during the sequence of tearing off a paper sheet will concomitantly leave a short segment of a next segmented, paper sheet to grasp for a subsequent dispensing operation.

Another object of the invention is to provide a design that promotes tearing from a table top dispenser in a manner that will not tip over the dispenser.

A further object of the invention is to provide a ratio of base weight to coefficient of friction of a frictional tearing bar and a paper towel dispensing unit.

### BRIEF SUMMARY OF A PREFERRED EMBODIMENT OF THE INVENTION

A preferred embodiment of the invention, which is intended to accomplish at least some of the foregoing objects, includes a single hand, paper sheet dispenser comprising a base, a core holder operable to rotatably hold a roll of segmented, paper sheet segments connected together end-to-end along perforated tear lines, and a single hand paper sheet dispensing member. The single hand dispensing member includes a high friction gripping member. The frictional gripping element of the dispensing member is positioned between an external surface of a roll of paper sheets and an interior surface of an unreeled free end of the roll. Accordingly, the frictional gripping element allows a number of paper sheets to be dispensed while operably securing the roll in position by having a frictional outer surface segment and at least one arcuate inner surface segment, such that individual sheets of a segment paper sheet roll can be facilely dispensed with one hand.

### DRAWINGS

Other objects and advantages of the present invention will become apparent from the following detailed description of a preferred embodiment thereof taken in conjunction with the accompanying drawings, wherein:

FIGS. 1 and 2 are the frictional elements having different cross-sectional shapes;

FIGS. 3 and 4 are axonometric views of the table top embodiment disclosing a base sitting free on a generally horizontal surface. The figures differ in the contact point of unreeled paper towel segments on the frictional element;

FIGS. 5 and 6 are axonometric views of the dispenser mounted to hang beneath a horizontal surface, for example the underside of a kitchen cabinet;

FIGS. 7 AND 8 are axonometric views of the dispenser mounted on a vertical surface;

FIG. 9 is a side view of a table top dispenser, with the paper towel roll removed, which displays a core holding device.

FIGS. 10 and 11 show that the same vertically mounted dispensers can be configured to as to be loaded the right or left;

FIG. 12 is an intermediate view of a vertically mounted dispenser being reconfigured for mounting beneath a horizontal surface as shown in FIGS. 5 and 6;

FIGS. 13-21 show the frictional gripping element set into multiple alternative desired angles with respect to the base.

FIG. 22 shows an axonometric view of a table top dispenser having a short dispensing member to promote tearing from the bottom edge of the paper towel segment.

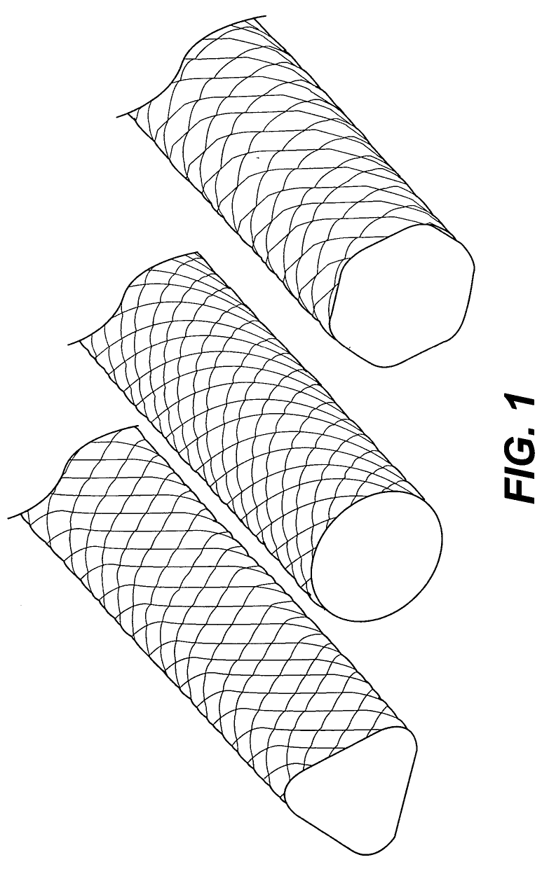

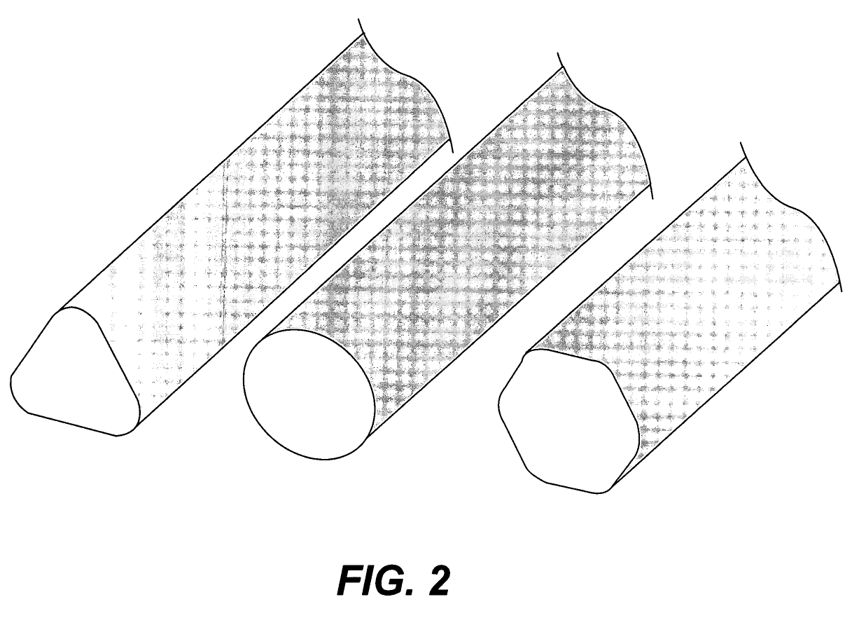

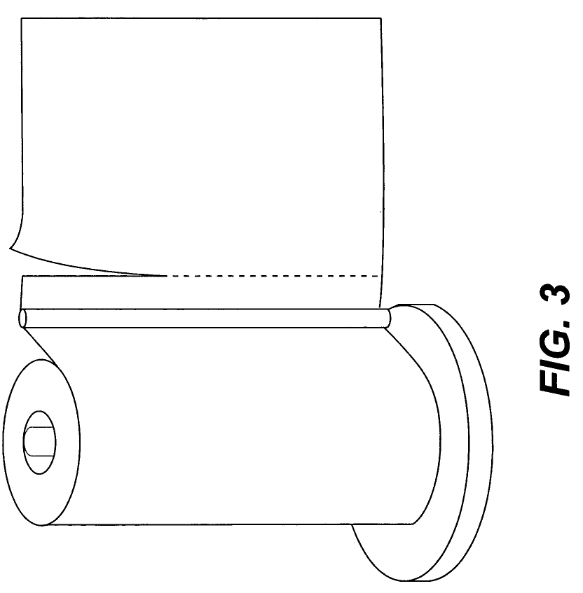

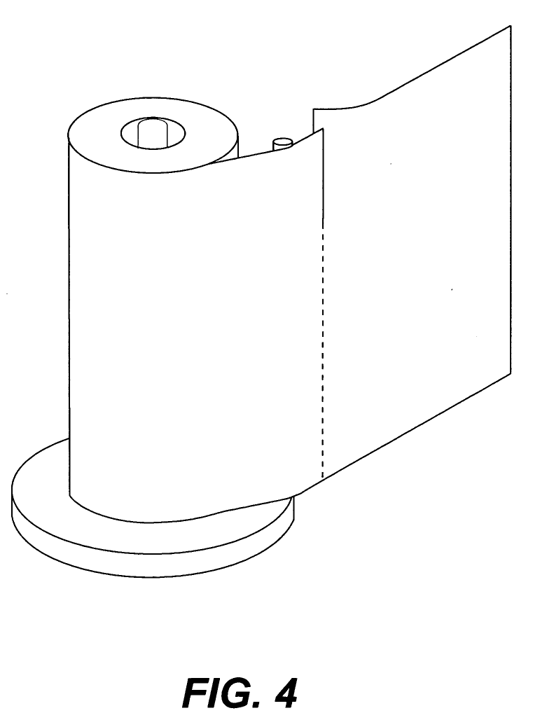

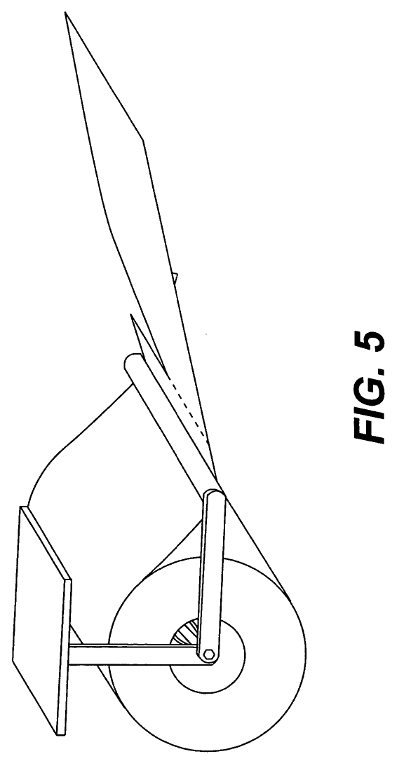

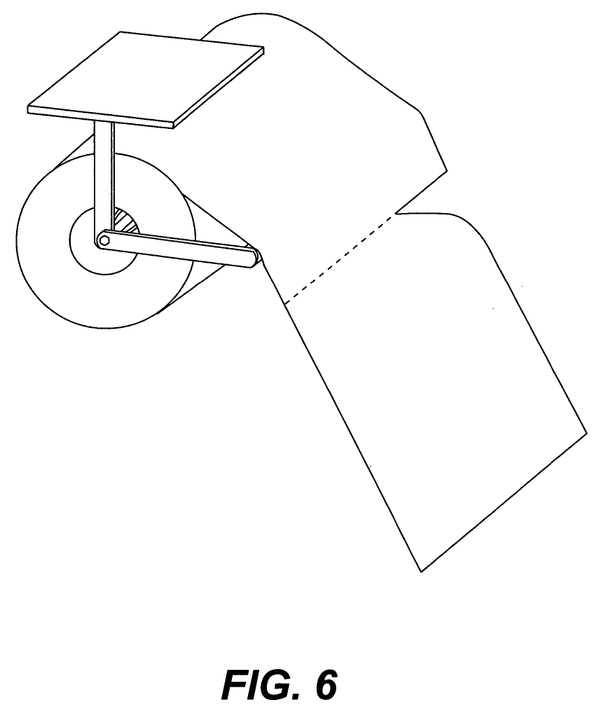

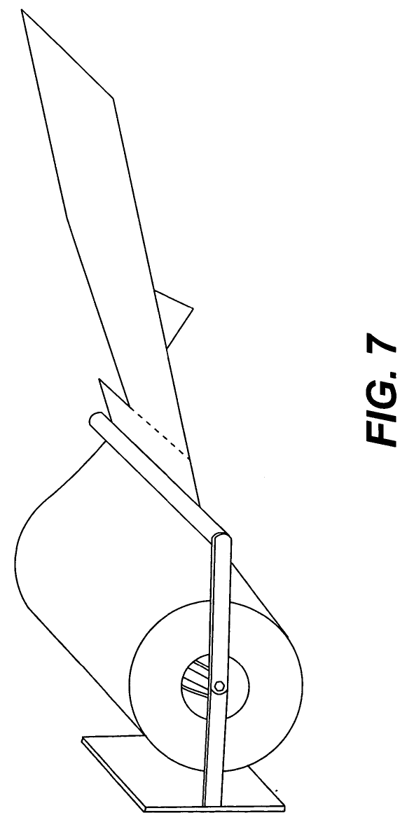

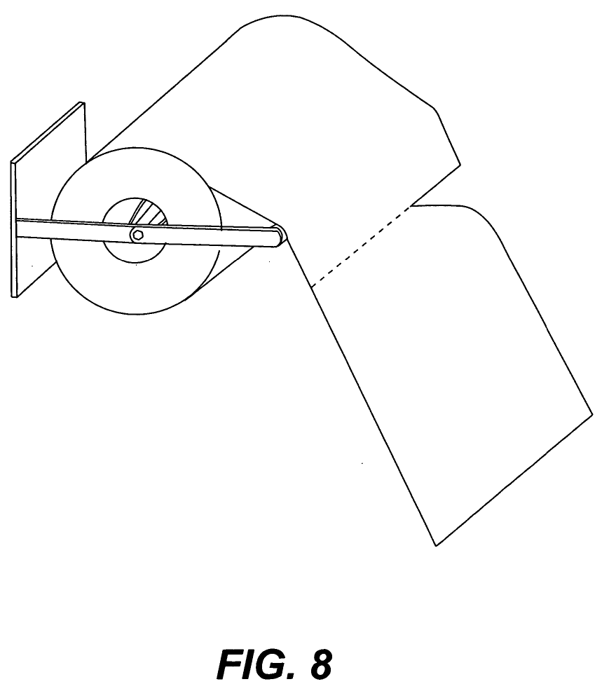

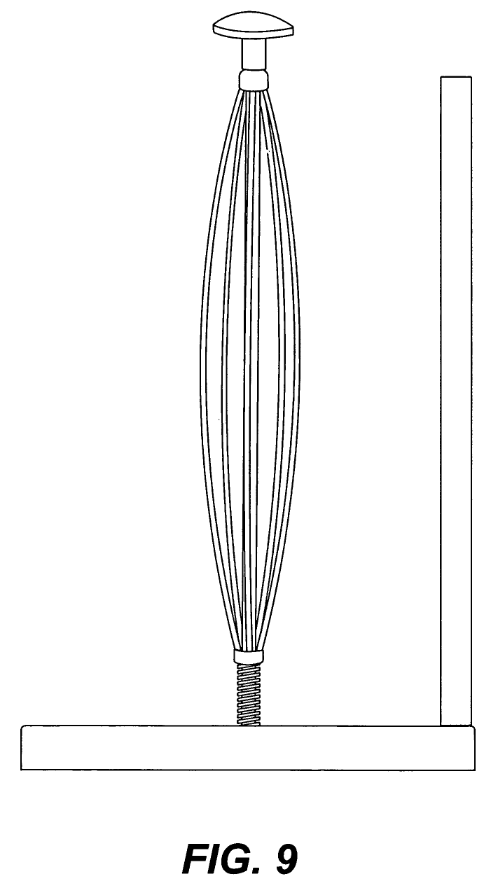

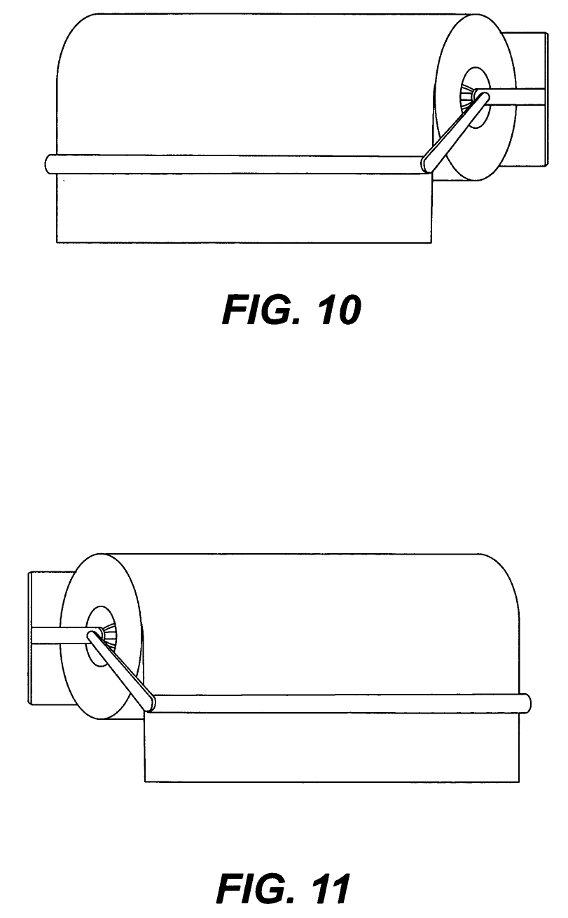

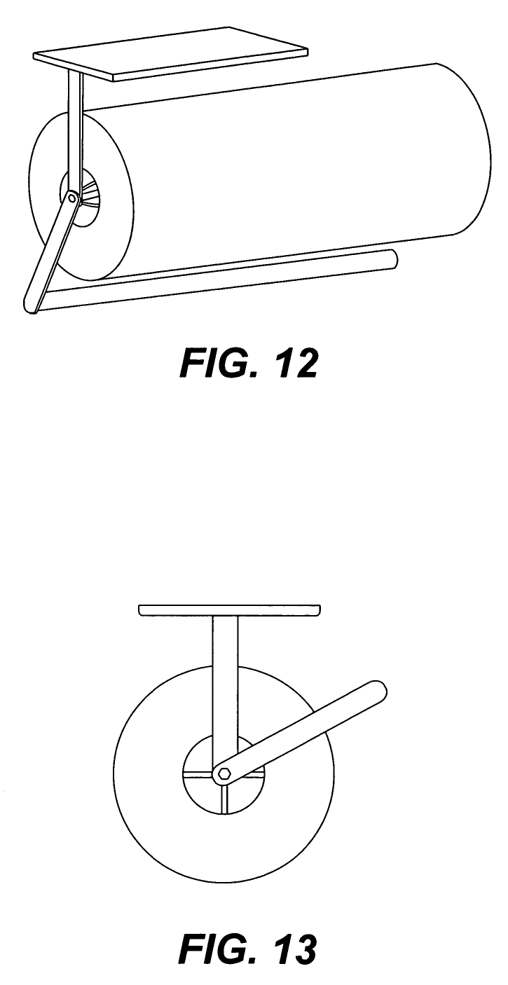

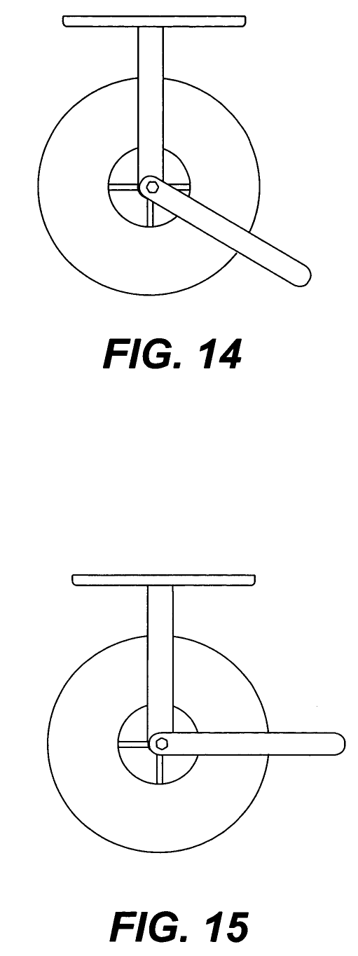

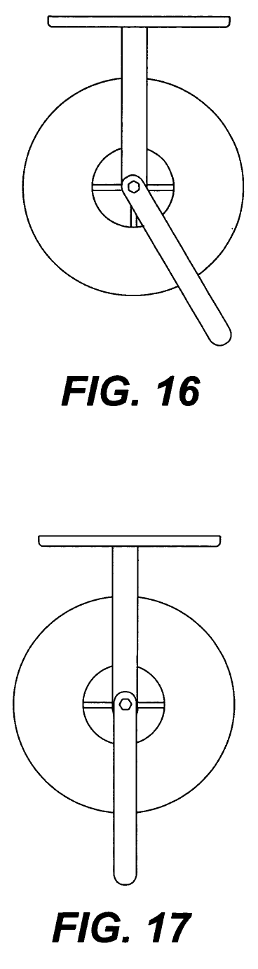

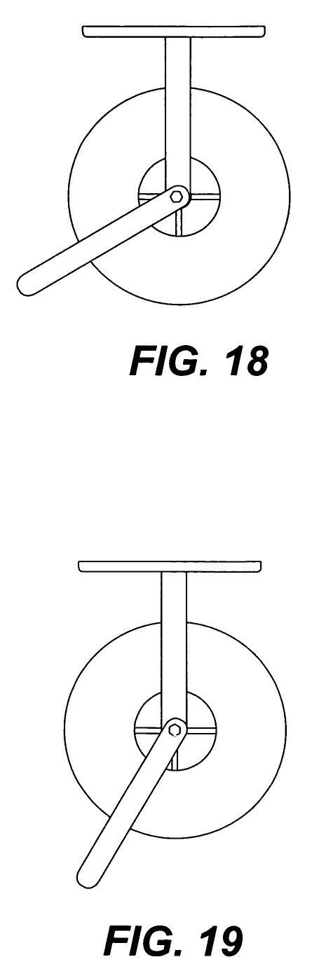

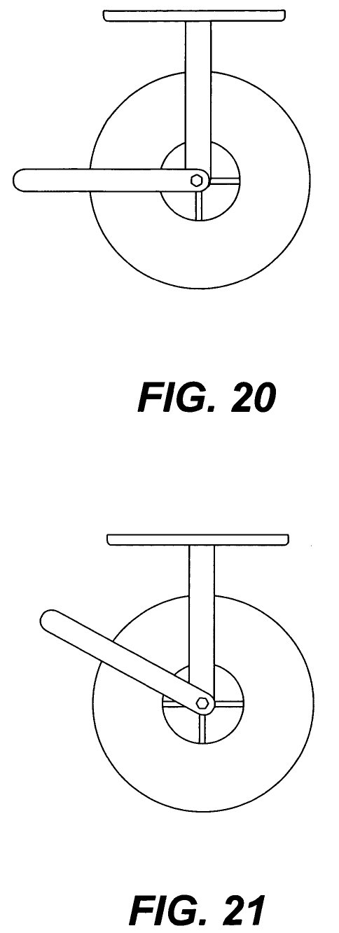

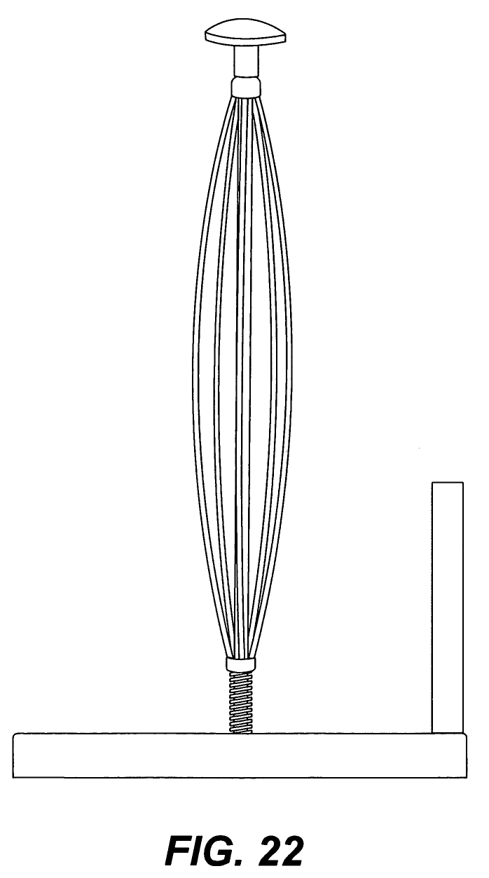

### DETAILED DESCRIPTION

Context of the Invention

The invention is directed to a novel paper sheet dispenser. The dispenser comprises a base for mounting to, or resting on, a support surface, a core holder operable for carrying a roll of segmented paper sheets, and a paper sheet-dispensing member. The dispensing member includes a dispensing member which, during a dispensing operation is held in a fixed position. The member comprises a frictional gripping element, which is connected to the base, containing a frictional outer surface where paper sheets are unreeled for dispensing. The frictional surface of the frictional gripping element grips an unreeled portion of the roll, effectively preventing further unreeling and allows paper sheets to be dispensed with the use of only one hand.

The paper sheet dispenser is mountable on either a generally vertical surface or a generally horizontal surface. Alternatively, the dispenser can rest on a generally horizontal surface. A desired number of paper sheets may be dispensed by pulling the unreeled sheets in a motion away from the frictional surface of the frictional gripping element. Once a desired number or number of sheets has been unreeled from the paper sheet roll, past the frictional gripping element, those sheets may be disengaged from the roll by pulling the dispensed sheets in a motion that engages a portion of the unreeled paper sheets with the frictional surface of the frictional gripping element. The frictional force between the paper sheets and the frictional surface allows a desired number of sheets to be facilely separated from the roll of paper sheets by a smooth downward and angled pulling stroke.

Frictional Dispensing Element

One preferred embodiment of the invention is shown in accordance with the invention. In this embodiment of the invention, a base member is formed from a generally rectangular member, which is operable to be mounted on a vertical or horizontal surface. Alternatively, the base may be round, oval, square or even irregular as desired. Further, the base may rest on a generally horizontal surface.

The base operably serves to carry a core holder. The core holder serves to pivotally carry a core-carrying member. The core holder can have a multitude of distinctly shaped structures, including an elongate segments stamped out of the member, or two or more segments connected to the lower portion of the base.

The core-carrying member may be formed in a number of generally cylindrical shapes, including, but not limited to, a spiral-shaped wire cage. Another shape of the core-carrying member can be a molded plastic unit that has voids throughout its length but is generally fashioned in the shape of a cylinder. Regardless of the material, or exact shape, the core carrying member snuggly but releasably engages the interior surface of a paper core of a roll of paper sheets without relative rotation. The core carrying member, however, is pivoted upon, and free to rotate about, the second rod of the core holder. The diameter of the core carrying member can vary but is generally the size of a conventional paper core of a roll of paper sheets, such as paper towels or bathroom tissue.

In addition to the core holder the base operably carries, via a pivotal connection, a frictional free hand dispensing member. The dispensing member is connected to the core holder by a pivot sleeve.

The core holder and dispensing member are preferably composed of a heavy gauge solid wire construction so that they are rugged. Other materials and shapes such as tubular plastic bars are envisioned and may be used, however, a heavy wire composed of painted or plated low-grade steel, or even stainless steel, is presently preferred.

The dispensing member is a generally elongated member having a main axis parallel to the axis of rotation of the roll of paper towels. The member is fashioned with a frictional gripping element. The frictional gripping element is operable to extend transversely across an exterior surface of a roll of paper sheets, mounted upon the core holder.

The dispensing member is operably positioned between the exterior surface of a roll of paper towel sheets and the segments on an unreeling portion of the roll of paper towel sheets. Alternatively, the dispensing member can be positioned so as to contact the outer surface of the unreeling portion of the roll. In still another alternative, the member is positioned such that the unreeling portion can be positioned such that it contacts the member on either its inner or outer surface.

A roll of paper sheets is usually formed with transverse serrated or score lines across the sheets to facilitate separation. Accordingly, if an amount of paper sheet are drawn out, generally horizontally, or unreeled to a desired amount, by a user's single hand, until a score line is an inch or two beyond the frictional gripping element, downward motion by the user will cause friction between the frictional gripping element and the paper sheets.

The frictional gripping element is, as described above, positioned above an exterior surface of a roll of paper sheets. The frictional gripping element functions to contact the exterior surface of a roll, assisting in preventing unwanted unreeling of a roll, while concomitantly providing a frictional surface to allow for single handed dispensing operation in certain embodiments of the invention.

In alternative embodiments, the frictional gripping element is free standing and suspended, functioning primarily to provide a frictional surface for single handed dispensing operation. Further, in this embodiment, the frictional gripping element does not require a passive segment, and the complete outer surface of the element may be composed of a frictional pattern and/or material.

With respect to the free standing table top preferred embodiment, several improvements are envisioned over prior art dispensers. The base must have sufficient weight in proportion to the force required to tear a paper towel sheet from the roll. In particular, the base must be heavy enough to that the dispenser will not tip over when the user attempts to tear a sheet from the roll. In this, the dispenser must have a ratio of weight to frictional force sufficiently great to that the dispenser will not tip. In a preferred embodiment the base weights at least about 2 pounds. In another preferred embodiment the base weights at least about 3 pounds. In still another preferred embodiment, the base weights at least about 4 pounds.

In an alternative embodiment, the length of the dispensing member (or alternatively, the frictional gripping element) is shorter than the length of the paper towel roll. In this embodiment, it is critical that the dispensing member does not extend high enough to reach the upper edge of the paper towel roll. This alignment discourages the user from tearing the sheets off from the upper edge of the roll of paper towels. There is no dispensing member against which the unreeled paper towel segments can be pressed. Instead, the user is encouraged to tear from the lower edge. In a preferred embodiment the length of the frictional gripping element is about half of the length of the paper towel roll. In another preferred embodiment, this element is about a third of the length of the core holder.

In yet another embodiment, the invention is designed to be bidirectional in that a user might want to install the segmented, paper sheet dispenser of the present invention so that the core carrying member can be loaded from either the right side or left side of the dispenser. For example in mounted dispensers, bidirectionality is achieved as a result of repositioning the dispensing member to the other side of the base plate. Then the user reinserts the core carrying unit in the other end of the base plate, such that the mounting arm is inserted through the elongate sleeve segment from the opposite direction.

A frictional gripping element can be positioned between the free end of a roll of paper sheets and the exterior of the coiled roll. Gently pulling on the free end of a roll of paper sheets, at an angle such that the unreeled sheets are not pressed into contact with the frictional element of the dispensing member, will unreel a number of sheets.

After a desired number of segments is unreeled and a serrated line is extended an inch or so beyond the frictional gripping element, the angle in which the sheets are unreeled is changed to that a surface of the unreeled paper towel segments not are pressed into contact with the frictional element on the dispensing member. This contact will create friction between the paper towel and the frictional segment of the frictional gripping element which will create a clean, one handed tear, along serration line of the roll of sheets.

Various embodiments of a frictional gripping element are envisioned in accordance with one preferred embodiments as described. Moreover, the FIGURES are intended to exemplify three characteristics: 1) general shape of the frictional gripping element 2) frictional segment surface patterns; and 3) frictional segment surface materials. Various combinations of these characteristics, as exemplified in the FIGURES, are envisioned as preferred embodiments, although not all combinations are shown.

A frictional gripping element can comprise a frictional segment that is a generally planar section with mutually parallel ridges extending longitudinally along the outer surface of the frictional gripping element. In addition, one particular embodiment of the shape of the frictional gripping element has a planar frictional segment which can have various frictional surfaces, including, but not limited to, those patterns and materials found in the FIGURES.

A frictional gripping element can have a frictional segment which is a generally crowned section with a diagonal hatch or cross pattern of recesses within the outer surface of said frictional gripping element.

A frictional gripping element can comprise a generally crowned section with mutually parallel rows of raised protrusions extending from the outer surface of the frictional gripping element.

A frictional gripping element can have a frictional segment with a generally crowned section with a diagonal hatch or cross pattern of ridges along the outer surface of said frictional gripping element.

A frictional gripping element can comprise a frictional segment having a generally circular section with mutually parallel ridges extending longitudinally along the outer surface of the frictional gripping element. Yet another embodiment of the shape of the frictional gripping element is generally round. This particular shape of a frictional gripping element can facilitate various combinations of frictional surface patterns and materials, as depicted throughout the FIGURES.

The frictional segment can be is a generally crowned section with an elastomeric coating on the outer surface of the frictional gripping element. The elastomeric coating creates friction due to the material characteristics, and does not have to be textured.

Other embodiments of a frictional gripping element, not shown in the FIGURES or described above, include a textured surface of the frictional segment made of an elastomeric coating, providing enhanced gripping characteristics for the frictional segment.

Additionally, the frictional gripping element does not require a passive segment contacting the roll as is depicted in prior art dispensers. The frictional element does not contact the exterior of the wound roll. In one particular embodiment the entire outer surface of the frictional gripping element may be composed of a frictional surface, i.e., a frictional pattern and/or frictional material, allowing a user to tear away segmented paper sheets with any motion creating friction between an unreeled portion of the roll of sheets and the frictional gripping element.

In another particular embodiment the frictional gripping element has a peripheral surface having a wide generally arc-shaped conformation. The outer surface shape of the frictional gripping element can thus be altered to increase contact between the element and the paper sheets.

In yet another embodiment, the frictional gripping element is an arcuate bar having both smooth and frictional surfaces. In a preferred embodiment, the smooth surfaces and frictional surfaces run parallel and extend the length of the frictional gripping element and are mutually parallel. The smooth ends are passive segments of the frictional gripping element. The other segments, active segments of the frictional gripping element, can contain a frictional segment made of a high friction material and/or a textured surface along its exterior.

Major Advantages of the Invention

Without attempting to identify all of the advantages specifically identified and inherently disclosed in the foregoing specification those of skill in the art will recognize several advantages of the subject invention. Specifically, a single frictional gripping element enables facile one handed tearing of sheet segments from a roll.

The single frictional gripping element does not require threading of the paper sheets through a dispensing bale, and the high friction surface enables facile tearing of a desired number of sheet segments.

The frictional gripping element is substantially unaffected by the decreasing size of a dispensing roll. The frictional gripping element does not contact the outer surface of a roll of paper sheets and primarily functions to provide a frictional surface, allowing for single-handed dispensing operation.

The varied patterns and materials used to create a high friction outer surface for the frictional gripping element provides sufficient with respect to unreeling of a roll of paper sheet segments to provide facile tearing of a desired number of sheets.

Other embodiments of a frictional gripping element, not shown in the FIGURES or described above, include a frictional segment made of an elastomeric coating and containing a selected friction pattern to provide enhanced gripping characteristics.

The relatively short length of the dispensing member will promote stable operation of the table top dispensers. In particular, this feature discourages attempts to tear from the top edge of the paper towel roll, a practice that is more likely to topple a table top dispenser. Instead, tearing from the bottom edge is encouraged.

In describing the invention, reference has been made to preferred embodiments and illustrative advantages of the invention. Those skilled in the art, however, and familiar with the instant disclosure of the invention, may recognize additions, deletions, modifications, substitutions, and other changes which will fall within the purview of the subject invention.

1. A single hand paper towel dispenser comprising:
a base member operable to be mounted upon a generally planar surface;
a core holder for a roll of paper towel segments connected together end-to-end along transverse perforated tear lines, said core holder having a central longitudinal axis and is connected to said base, said core holder being operable to rotatably support the roll of paper towel segments; and
a dispensing member, said dispensing member connected to said base and having a frictional gripping element, said frictional gripping element having a high friction segment operable to extend transversely across an exterior surface of a roll of paper sheets mounted upon the core holder.

2. A single hand, paper towel dispenser as defined in claim 1 wherein:
said frictional gripping element is operably positioned between an external surface of the roll of paper sheets and an interior surface of an unreeled free end of the roll.

3. A single hand, paper towel dispenser as defined in claim 1 wherein:
said dispensing member is operably positioned so as to contact the outer surface of the unreeling portion of the roll of paper sheets.

4. A single hand, paper towel dispenser as defined in claim 1 wherein:
said core holder and dispensing member are preferably composed of a heavy gauge solid wire construction.

5. A single hand, paper towel dispenser as defined in claim 1 wherein:
said dispensing member is a generally elongated member having a main axis parallel to the axis of rotation of the roll of paper sheets.

6. A single hand, paper towel dispenser as defined in claim 1 wherein:
said dispensing element is free standing and suspended, said dispensing element being operable to provide a frictional surface for single handed dispensing operation.

7. A single hand, paper towel dispenser as defined in claim 1 wherein:
said base is free standing.

8. A single hand, paper towel dispenser as defined in claim 7 wherein:
said base weight is greater than the frictional force so that the dispenser will not tip.

9. A single hand, paper towel dispenser as defined in claim 8 wherein:
said base weighs at least 2 pounds.

10. A single hand, paper towel dispenser as defined in claim 1 wherein:
said base weighs at least 3 pounds.

11. A single hand, paper towel dispenser as defined in claim 1 wherein:
said base weighs at least 4 pounds.

12. A single hand, paper towel dispenser as defined in claim 1 wherein:
said dispensing member is shorter in length than the roll of paper sheets.

13. A single hand, paper towel dispenser as defined in claim 12 wherein:
the length of said dispensing member is half of the length of the roll of paper sheets.

14. A single hand, paper towel dispenser as defined in claim 1, and further comprising:
A pivot sleeve coupled to said dispensing member, said pivot sleeve being operable to connect said dispensing member to said base.

15. A single hand, paper towel dispenser as defined in claim 14, and further comprising:
a mounting arm inserted through said sleeve, said mounting arm being operable to be bi-directionally inserted through said sleeve from both ends of said sleeve.

16. A single hand, paper towel dispenser as defined in claim 1 wherein:
said friction segment is generally planar and having mutually parallel ridges extending longitudinally along the outer surface of said frictional gripping element.

17. A single hand, paper towel dispenser as defined in claim 1 wherein:
said friction segment has a generally crowned section having at least one of a diagonal hatch and cross pattern of recesses within the outer surface.

18. A single hand, paper towel dispenser as defined in claim 1 wherein:
said friction segment has a generally circular section with mutually parallel ridges extending longitudinally along the outer surface of said frictional gripping element.

19. A single hand, paper towel dispenser as defined in claim 1 wherein:
said friction segment comprises a generally crowned section with an elastomeric coating on the outer surface of said frictional gripping element.

20. A single hand, paper towel dispenser as defined in claim 1 wherein:
said friction segment comprises a textured surface made of an elastomeric coating.

21. A single hand, paper towel dispenser as defined in claim 1 wherein:
the entire surface of said frictional gripping element comprises a frictional surface.

22. A single hand, paper towel dispenser as defined in claim 1 wherein:
said frictional gripping element has a peripheral surface having a wide generally arcuate-shaped conformation.

23. A single hand, paper towel dispenser as defined in claim 1 wherein:
said frictional gripping element is an arcuate bar having both smooth and frictional surfaces, said smooth and frictional surfaces running parallel and extending the length of said frictional gripping element and being mutually parallel.

24. A single hand, paper towel dispenser as defined in claim 1 wherein:
said base comprises a solid, rectangular mounting pad having a flat surface operably adjoining said generally planar surface to provide a stable support for said core holder and said dispensing member.

25. A single hand, paper towel dispenser as defined in claim 2 wherein:
said base comprises a solid, rectangular mounting pad having a plurality of mounting apertures operable to support mounting of said core holder and said dispensing member.

26. A single hand, paper towel dispenser as defined in claim 2 wherein:
said base comprises a solid, rectangular mounting pad fitted with a magnet operable for mounting said paper towel dispenser to a metallic, generally vertical, surface.

27. A single hand, paper towel dispenser as defined in claim 2 wherein:
said base comprises a solid, rectangular mounting pad fitted with a transparent cover operable for displaying photographs and other insignia on a visible generally planar surface of said base.

28. A single hand, paper towel dispenser as defined in claim 1 wherein:
said core holder is formed from a generally U-shaped heavy gauge wire having a first holder arm mounted upon said base and a second holder arm, extending generally parallel with said first holder arm and being operable for receiving a core of a roll of paper towel segments.

29. A single hand, paper towel dispenser as defined in claim 28 wherein:
said first holder arm is pivotally mounted upon said base and said second holder arm carries a core carrying member, said core carrying member being pivotally mounted upon said second holder arm.

30. A single hand, paper towel dispenser as defined in claim 29 wherein:
said core carrying member is formed having a generally cylindrical exterior configuration for releasable but firmly engaging the interior surface of a cylindrical core of the roll of paper towel segments such that in operation there is no relative rotation between said core carrying member and said cylindrical core of the roll of paper towel segments.

31. A single hand, paper towel dispense as defined in claim 1 wherein:
said core holder comprises a molded plastic unit having voids throughout its length and having a generally cylindrical shape.
